(19) United States
(12) Patent Application Publication
(10) Pub. No.: US 2023/0311854 A1
(43) Pub. Date: Oct. 5, 2023

(54) AUTONOMOUS VEHICLE GARAGE PARKING

(71) Applicant: Continental Autonomous Mobility US, LLC, Auburn Hills, MI (US)

(72) Inventors: Joseph Burtch, Lake Orion, MI (US); Nizar Ahamed, Farmington Hills, MI (US); Nithin Joseph Pathalil, Lake Orion, MI (US); Pedro Alfonso Patlan Rosales, Queretaro (MX)

(73) Assignee: Continental Autonomous Mobility US, LLC, Auburn Hills, MI (US)

(21) Appl. No.: 17/656,976

(22) Filed: Mar. 29, 2022

(51) Int. Cl. B60W 30/06; G08G 1/14; B60W 60/00

(52) U.S. Cl. CPC B60W 30/06; B60W 2552/00; B60W 60/001; G08G 1/145

(57) ABSTRACT

A method system for aligning an autonomous vehicle path within an enclosed parking space provides for detecting sides of an opening of an enclosed parking space with at least one sensor system disposed on a vehicle, determining a width of the opening based on a spacing between the detected sides of the opening with a controller of the vehicle, defining a target center point based on the determined spacing with the controller and aligning a vehicle path with the defined target center point.

### TECHNICAL FIELD

The present disclosure relates to a method and system for operating an autonomous vehicle entering a garage or other enclosed parking area.

### BACKGROUND

Automated driving and driver assist systems gather information about an environment surrounding a vehicle and use that information to plan movement to a desired destination. A garage or other enclosed parking area is a common destination for an autonomous vehicle. Aligning and moving an autonomous vehicle into a garage parking space present challenges that are different than operation on a roadway. Moreover, garages often do not have open free space that corresponds with the garage door opening. Automotive manufactures are continuously seeking more efficient information processing methods to improve operation of vehicle systems.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of aligning an autonomous vehicle path within an enclosed parking space according to a disclosed example embodiment includes, among other possible things, detecting sides of an opening of an enclosed parking space with at least one sensor system disposed on a vehicle, determining a width of the opening based on a spacing between the detected sides of the opening with a controller of the vehicle, defining a target center point based on the determined spacing with the controller, and aligning a vehicle path with the defined target center point.

An embodiment of the foregoing method further includes identifying whether the target center point is within a definable area proximate the vehicle and aligning the vehicle path responsive to the target point being within the definable area.

In an embodiment of any of the foregoing methods, the target center point is halfway between the detected sides.

An embodiment of any of the foregoing methods further includes detecting fee space within the enclosed parking space with the at least one sensor system and realigning the target center point within the enclosed parking space based on the detected free space.

An embodiment of any of the foregoing methods further includes identifying a vehicle capacity for the enclosed parking space based on the determined width.

An embodiment of any of the foregoing methods further includes dividing the determined width by the number of possible enclosed parking spaces to define a parking space width of each of the possible enclosed parking spaces and defining the target center point as being centered on one of the defined parking space widths.

An embodiment of any of the foregoing methods further includes determining the number of possible parking spaces by dividing the overall width by a predefined car width.

An embodiment of any of the foregoing methods further includes aligning the target center point to correspond with a center of one of a plurality of parking spaces in response to the vehicle capacity of the enclosed parking space being more than one.

An embodiment of any of the foregoing methods further includes saving the target center point in a memory device of the vehicle and confirming the saved target center point based on the detected sides.

An embodiment of any of the foregoing methods further includes realigning the target center point in response to the saved target center point not corresponding to a center point based on a current spacing between detected sides.

An autonomous vehicle control system according to another disclosed example embodiment includes, among other possible things, a controller configured to control operation of an autonomous vehicle, the controller configured to align an autonomous vehicle path within an enclosed parking space by detecting sides of an opening of an enclosed parking space with information received from at least one sensor system disposed on the autonomous vehicle, determining a width of the opening based on a spacing between the detected sides of the opening, defining a target center point based on the determined spacing and aligning a vehicle path with the defined target center point.

In another embodiment of the foregoing autonomous vehicle control system,

the controller is further configured to identify whether the target center point is within a definable area proximate to the vehicle based on information received from at least one sensor system disposed within the vehicle and to align the vehicle path responsive to the target point being within the definable area.

In another embodiment of the foregoing autonomous vehicle control system, the controller is configured to identify a vehicle capacity for the enclosed parking space based on the determined width.

In another embodiment of the foregoing autonomous vehicle control system, the controller is configured to determine a number of possible enclosed parking spaces by dividing the determined width by a predetermined width of the vehicle and further to define a parking space width of each of the possible enclosed parking spaces.

In another embodiment of the foregoing autonomous vehicle control system, the controller is further configured to cause an alignment with the target center point that corresponds with a center of one of a plurality of parking spaces in response to the vehicle capacity of the enclosed parking space being more than one.

In another embodiment of the foregoing autonomous vehicle control system, the controller is further configured to save a target center point in a memory device of the vehicle and to confirm that the saved target center point corresponds with a center point determined based on a location of the detected sides of the opening.

In another embodiment of the foregoing autonomous vehicle control system, the controller is further configured to realigning the path of the autonomous vehicle in response to the saved target center point not corresponding to a center point based on a current spacing between detected sides.

A non-transitory computer readable storage medium including instructions for operating an autonomous vehicle control system according to another embodiment of this disclosure includes instructions prompting a controller to align an autonomous vehicle along a path into an enclosed parking space by detecting sides of an opening of an enclosed parking space with at least one sensor system disposed on a vehicle, determining a width of the opening based on a spacing between the detected sides of the opening with a controller of the vehicle, defining a target center point based on the determined spacing with the controller, and aligning a vehicle path with the defined target center point.

Another embodiment of the foregoing non-transitory computer readable storage medium includes instructions prompting the controller to detecting free space within the enclosed parking space with the at least one sensor system and realigning the target center point within the enclosed parking space based on the detected free space.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of a vehicle including an autonomous vehicle control system for aligning a vehicle path within an enclosed parking space.

FIG. 2 is a flow diagram of an example vehicle path alignment process.

FIG. 3 is a schematic view of an example vehicle control system embodiment detecting sides of an enclosed parking space.

FIG. 4 is a schematic view of an example vehicle control system embodiment detecting free space within the enclosed parking space.

FIG. 5 is a schematic view of a saved location of a center line of vehicle parking space relative a detected centerline.

FIG. 6 is a schematic view of a revised location of a centerline of the vehicle parking space based on the detected centerline.

FIG. 7 is a schematic view of an example vehicle control system embodiment detecting sides of an enclosed parking space for more than one vehicle.

FIG. 8 is a schematic view of an example vehicle control system embodiment detecting free space within the enclosed parking space.

FIG. 9 is a schematic view of a saved location of a centerline of vehicle parking space for a multi-vehicle parking area relative to a detected centerline.

FIG. 10 is a schematic view of a revised location of a centerline of the vehicle parking space for a multi-vehicle parking area based on the detected centerline.

### DETAILED DESCRIPTION

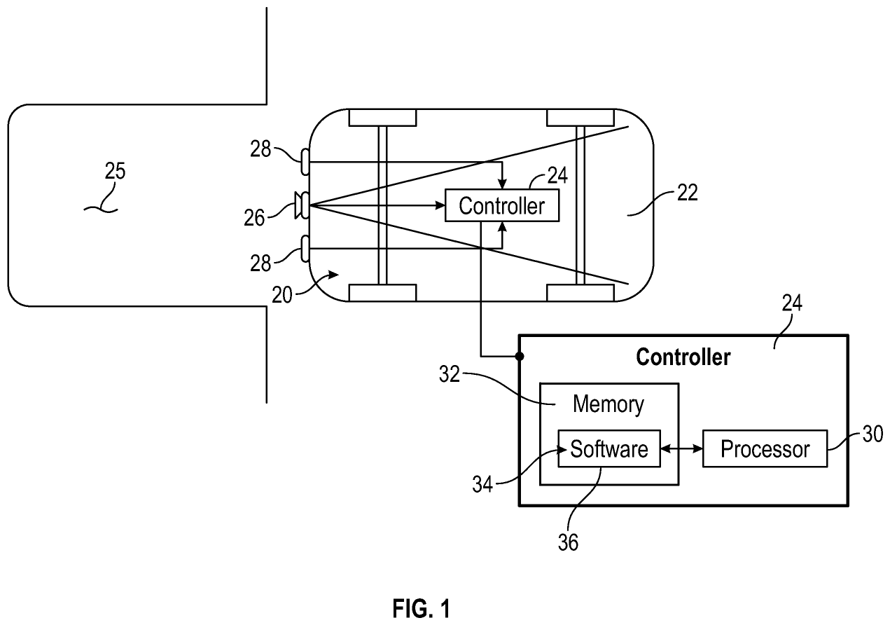

Referring to FIG. 1, a vehicle control system 20 for autonomously aligning a vehicle 22 with an enclosed parking space is schematically shown. The example control system 20 is embodied in a controller 24 that receives information from vehicle mounted sensors and operates according to software instructions 34 to align the vehicle 22 along a centered path into an enclosed parking space 25. The parking space 25 may be within a single or multi-vehicle garage or other enclosed and/or covered parking structure. Parking is typically performed at a substantially reduces speed and in confined environments with little room for inaccuracies. Information provided from external systems may not provide accuracy sufficient for such parking operations. Accordingly, an example system embodiment provides for low speed parking with sensors disposed on the vehicle. The disclosed system 20 is embodied in operation of the controller 24 according to saved instructions.

The example controller 24 may be a separate controller dedicated to the control system 20 are may be part of an overall vehicle controller. Accordingly, the example controller 24 relates to a device and system for performing necessary computing or calculation operations of the control system 20. The controller 24 may be specially constructed for operation of the control system 20, or it may comprise at least a general-purpose computer selectively activated or reconfigured by the software instructions 34 stored in the memory device 32. The computing system can also consist of a network of (different) processors 30.

The example vehicle controller 24 includes the processor 30 and the memory device 32. The memory device 32 provides for the storage of the software instructions 34 that prompt operation of the processor 30 and system 20. The software instructions 34 may be embodied in a computer program that uses data stored in the memory device 32 that may be required for its execution.

The instructions 34 for configuring and operating the controller 24, control system 20 and the processor 30 are embodied in software instructions that may be stored on a computer readable medium, schematically shown at 36. The computer readable medium 36 may be embodied in structures such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable tor storing electronic instructions, and each coupled to a computer system bus. The disclosed computer readable medium may be a non-transitory medium such as those examples provided.

Moreover, the disclosed memory device 32, may can include any one or combination of volatile memory elements (e.g., random access memory (RAM, such as DRAM, SRAM, SDRAM, VRAM, etc.) and/or nonvolatile memory elements (e.g., ROM, hard drive, tape, CD-ROM, etc.). The software instructions 34 in the memory device 32 may include one or more separate programs, each of which includes an ordered listing of executable instructions for implementing logical functions. The disclosed controller 24 is configured to execute the software instructions 34 stored within the memory device 32, to communicate data to and from the memory device 32, and to generally control operations pursuant to the software. Software in memory, in whole or in part, is read by the processor 30, perhaps buffered within the processor, and then executed.

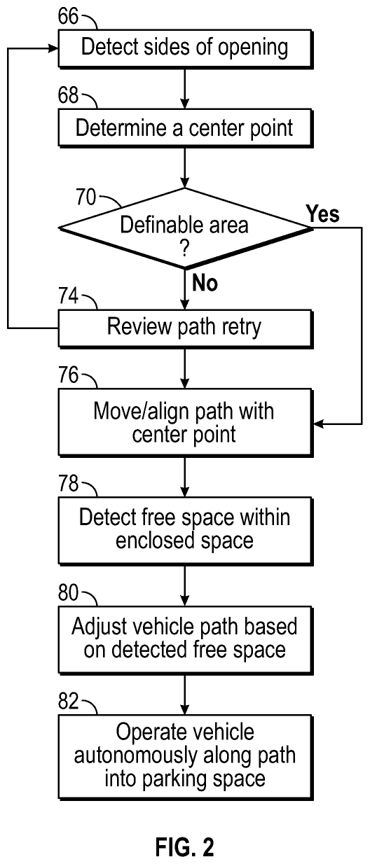

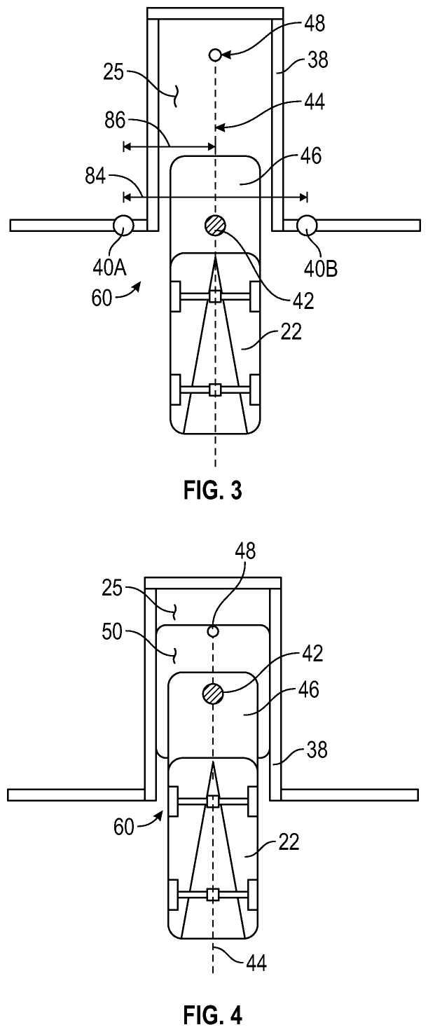

Referring to FIGS. 2 and 3 with continued reference to FIG. 1, process steps for aligning a path for a low speed parking operation for an autonomously operated vehicle is schematically shown in FIG. 2. A schematic view of a vehicle 22 approaching an enclosed parking structure 38 for parking at an end point 48 is shown in FIG. 3. Aligning a vehicle path 44 within the opening 62 to the garage 38 with little lateral and/or angular error is challenging. In one example disclosed process of operation of the vehicle control system 20, sides 40A and 40B of the opening 62 are detected as indicated at 66 in the flow diagram shown in FIG. 2.

The vehicle 22 includes various sensors that provide for detection of objects proximate to the vehicle 22. The disclosed example vehicle includes proximity sensors 28 and a camera 26 that provide for detection of the sides 40A and 40B. It should be appreciated that the proximity sensors 28 and camera 28 are disclosed by way of example and other vehicle sensor systems for detecting a surrounding environment may also be utilized and are within the scope and contemplation of this disclosure. Moreover, the proximity sensors 28 and camera 26 may be of any configuration that provides information indicative of a position of objects around the vehicle 22.

Once the location of the sides 40A and 40B are located, the control system 20 determines a distance 84 between the sides 40A and 40B as indicated at 68. The distance 84 between the detected sides 40A and 40B provides an indication of the size of the opening 60. The distance 84 is then divided by the number of vehicles that can be parked in the garage 38. In the example shown in FIG. 3, the garage 38 is a one car garage and therefore the center point 42 is half of the distance 84 as indicated at 86.

A confirmation that the center point 42 is performed to assure that the determined center point 42 lies within a definable area 46 (FIG. 3) as is indicated it the flow diagram at 70. The example system 20 operates with information that provides a mapping of the definable area 46 surrounding the vehicle 22. Prior to redefining the path 44, the system 20 confirms that the path 44 is within the predefined definable area 46. If the center point 42 is not within a predefined definable area, the control system will review and retry locating the center point as indicated at 74. Reviewing and retrying may include defining the area around the center point to be included within the definable area 46. In most instances, operation of the vehicle 22 for parking will occur in a vehicle owner's driveway or other familiar previously traveled area and therefore will be located in a definable area 46.

The determined center point 42 is then used to move and align the vehicle path 44 within the opening 60 as indicated in the flow diagram at 76. Alignment of the vehicle path 44 provides for the vehicle 22 to enter the garage 38 without contacting any of the structure.

Referring to FIG. 4, once a portion of the vehicle 22 has passed through the opening 60, the system 20 begins detecting free space within the garage 38. As appreciated a garage 38 is used for storage of many other items in addition to the vehicle 22. Those other stored items may limit the space for the vehicle 22 and require an alteration to the position of the vehicle 22 within the parking spot 25. Moreover, other objects within the garage may be obstacles that need to be removed prior to the vehicle 22 moving completely into the parking spot 25. Accordingly, the example process includes the step of detecting free space 50 (FIG. 3) as indicated in the flow diagram at 78. Detection of the free space 50 may be performed using the proximity sensors 28, the camera 26 and/or a combination of both. Images from the camera 26 may be analyzed to identify obstacles. The proximity sensors 28 may provide further information indicative an obstacle. Moreover, other vehicle sensors could be utilized to detect free space around the vehicle and within the garage.

In response to detection of an obstacle along the path 44, the system 20 may revise the path to accommodate and avoid any detected obstacle as is indicated in the flow diagram at 80. Once any required alterations to the vehicle path 44 are made, the system 20 operates the vehicle 22 to move along the path 44 toward the end point 48 and the parking space as indicated at 82 in FIG. 2.

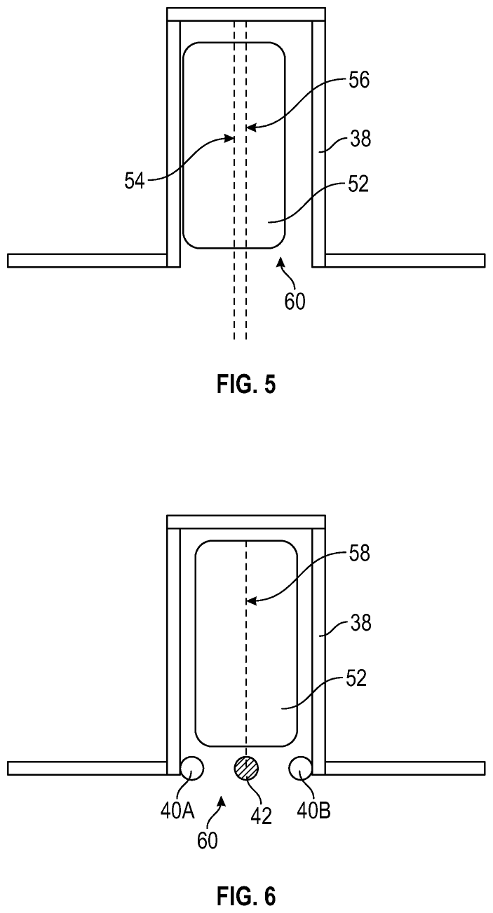

Referring to FIGS. 5 and 6 with continued reference to FIG. 1, once the vehicle 22 is parked in the garage 38, the location of the space 52 and the path 54 into the garage 38 is trained and may be saved for recall the next time the vehicle is prompted to park. The location of a trained and/or saved path along a center line 54 may not actually be along a centerline 56 of the garage. The difference between the saved centerline 54 and the actual centerline 56 may be due to a combination of tolerances in the sensing devices or drift due to factors that effect sensor operation. As appreciate, many factors may contribute to a drift from saved locations such as the center line 54. In one disclosed example embodiment, the system 20 detects such changes relative to sensed and actual locations.

The difference between the saved centerline 54 and the actual center 56 is determined utilizing the detected side points 40A and 40B of the opening 60 (FIG. 6). A corrected center line 58 based on the center point 42 between the side points 40A and 40B is determined and used for subsequent parking operations. The revision and correction for drift may be performed during vehicle parking operations or may occur to update parking location information upon parking of the vehicle 22.

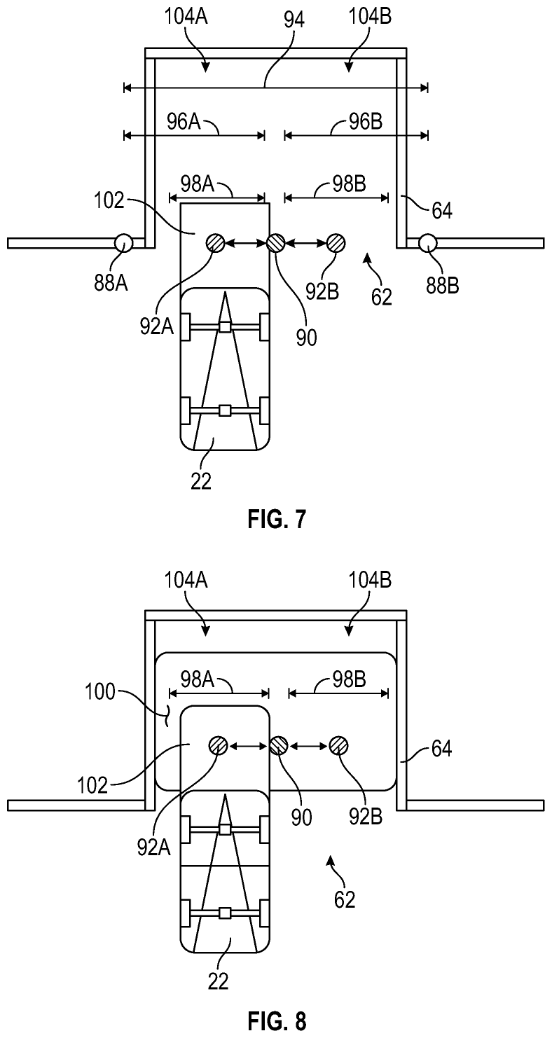

Referring to FIGS. 7 and 8 with continued reference to FIG. 1, another example process for centering a vehicle 22 is schematically shown for applications that involve a multi-vehicle garage 64. In this disclosed example, the garage 64 is a 2 car garage and therefore an additional step is performed to center the vehicle path with one of the parking spaces. In this example embodiment, the total width 94 of available space in the garage 64 is determined based on the location of the detected edges 88A and 88B of the opening 62. The edges or sides 88A and 88B are detected using sensors disposed on the vehicle 22, such as the camera 26 and/or the proximity sensors 28.

The total width 94 is then divided in half to find the center point 90. The center point 90 is an equal distance from each internal wall as indicated at 96A and 96B. A width of the vehicle 22 is also considered for each of the parking spaces 104A and 104B. The widths of vehicle are indicated at 96A and 96B. A center point 92A and 92B for each of the parking spaces 104A and 104B is determined as an offset from the center point 90. In one disclosed example embodiment, the center points 92A and 92B are offset from the center point 90 by a distance that is ½ the car width 98A and 98B. The car width may be a default distance that is applicable to most common vehicles and/or may be specific to the vehicle 22. Once the center points 92A and 92B are determined for each parking space 104A and 104B, one of the spaces is selected as the target parking spot. The selection between the available parking spaces 104A and 104B may be predefined for each vehicle. The selection between spots 104A and 104B may also be based on any other criteria selected by a vehicle owner.

Once the parking space is selected, the vehicle 22 will begin movement through the opening 62 along a path centered on the center point 92A, 92B corresponding toe the parking space 104A, 104B. In this example, parking space 104A is selected and therefore the vehicle path is centered on point 92A.

The path proceeds into a definable area indicated at 102 into the garage 64. As the vehicle 22 enters the garage 64, free space 100 is searched for any objects or obstructions. If an object or obstruction is detected, the vehicle path may be altered or the vehicle stopped until the obstruction if removed.

The example shown in FIGS. 7 and 8 is for a two-car garage 64 but is also applicable to larger garages and parking areas. However, even structures that provide for parking of more than two vehicles usually include an opening 62 to accommodate two vehicles. Accordingly, the detection of free space 100 provides the additional information needed to move the vehicle 22 to a parking space. Moreover, although each of the disclosed examples show a straight in parking path, other paths to accommodate different garage configurations and spaces are within the contemplation and scope of this disclosure.

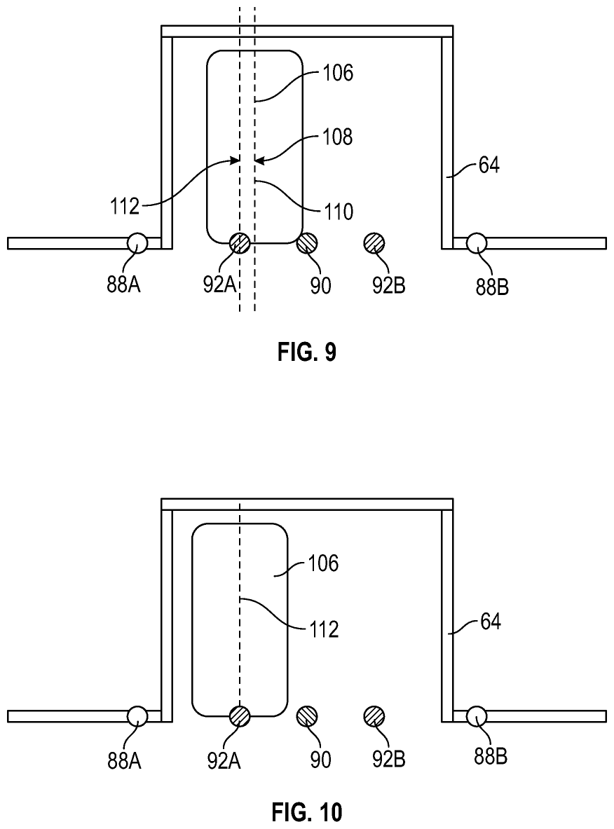

Referring to FIGS. 9 and 10, a trained or saved parking location 106 is shown within the two-car garage 64. The saved location 106 may be disposed along a line 110 that is spaced a distance 108 from an actual centerline 112 based on the center point 92A for the corresponding parking space. In one disclosed system embodiment, the saved location 106 is updated based on the sensed points within the enclosed space such that it is centered along the actual centerline 112 corresponding to center point 92A. The re-centering of the saved location 106 may occur each instance that the vehicle performs a parking operation in the garage 64. Repeated parking and re-centering of the vehicle improves accuracy such that any vehicle path into the garage is continually improved.

Accordingly, the disclosed example system embodiments provide for modification and confirmation of a vehicle path during low speed parking operations utilizing sensor systems mounted on the vehicle.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method of aligning an autonomous vehicle path within an enclosed parking space, the method comprising:
detecting sides of an opening of an enclosed parking space with at least one sensor system disposed on a vehicle;
determining a width of the opening based on a spacing between the detected sides of the opening with a controller of the vehicle;
defining a target center point based on the determined spacing with the controller; and
aligning a vehicle path with the defined target center point.

2. The method as recited in claim 1, further comprising identifying whether the target center point is within a definable area proximate the vehicle and aligning the vehicle path responsive to the target point being within the definable area.

3. The method as recited in claim 2, wherein the target center point is halfway between the detected sides.

4. The method as recited in claim 2, further comprising detecting fee space within the enclosed parking space with the at least one sensor system and realigning the target center point within the enclosed parking space based on the detected free space.

5. The method as recited in claim 1, further comprising identifying a vehicle capacity for the enclosed parking space based on the determined width.

6. The method as recited in claim 5, further comprising dividing the determined width by the number of possible enclosed parking spaces to define a parking space width of each of the possible enclosed parking spaces and defining the target center point as being centered on one of the defined parking space widths.

7. The method as recited in claim 6, including determining the number of possible parking spaces by dividing the overall width by a predefined car width.

8. The method as recited in claim 7, further comprising aligning the target center point to correspond with a center of one of a plurality of parking spaces in response to the vehicle capacity of the enclosed parking space being more than one.

9. The method as recited in claim 1, further comprising saving the target center point in a memory device of the vehicle and confirming the saved target center point based on the detected sides.

10. The method as recited in claim 9, further comprising realigning the target center point in response to the saved target center point not corresponding to a center point based on a current spacing between detected sides.

11. An autonomous vehicle control system comprising:
a controller configured to control operation of an autonomous vehicle, the controller configure to align an autonomous vehicle path within an enclosed parking space by detecting sides of an opening of an enclosed parking space with information received from at least one sensor system disposed on the autonomous vehicle, determining a width of the opening based on a spacing between the detected sides of the opening, defining a target center point based on the determined spacing and aligning a vehicle path with the defined target center point.

12. The autonomous vehicle control system as recited in claim 11, wherein the controller if further configured to identify whether the target center point is within a definable area proximate the vehicle based on information received from the at least one sensor system disposed within the vehicle and to align the vehicle path responsive to the target point being within the definable area.

13. The autonomous vehicle control system as recited in claim 12, wherein the controller is configured to identify a vehicle capacity for the enclosed parking space based on the determined width.

14. The autonomous vehicle control system as recited in claim 13, wherein the controller is configured to determine a number of possible enclosed parking spaces by dividing the determined width by a predetermined width of the vehicle and further to define a parking space width of each of the possible enclosed parking spaces.

15. The autonomous vehicle control system as recited in claim 14, wherein the controller is further configured to cause an alignment with the target center point that corresponds with a center of one of a plurality of parking spaces in response to the vehicle capacity of the enclosed parking space being more than one.

16. The autonomous vehicle control system as recited in claim 11, wherein the controller is further configured to save a target center point in a memory device of the vehicle and to confirm that the saved target center point corresponds with a center point determined based on a location of the detected sides of the opening.

17. The autonomous vehicle control system as recited in claim 16, wherein the controller is further configured to realigning the path of the autonomous vehicle in response to the saved target center point not corresponding to a center point based on a current spacing between detected sides.

18. A non-transitory computer readable storage medium including instructions for operating an autonomous vehicle control system, the computer readable storage medium including instructions prompting a controller to align an autonomous vehicle along a path into an enclosed parking space by detecting sides of an opening of an enclosed parking space with at least one sensor system disposed on a vehicle, determining a width of the opening based on a spacing between the detected sides of the opening with a controller of the vehicle, defining a target center point based on the determined spacing with the controller, and aligning a vehicle path with the defined target center point.

19. The non-transitory computer readable storage medium as recited in claim 18 further including instructions prompting the controller to detecting fee space within the enclosed parking space with the at least one sensor system and realigning the target center point within the enclosed parking space based on the detected free space.
